(19) United States
(12) Patent Application Publication
(10) Pub. No.: US 2017/0057563 A1
(43) Pub. Date: Mar. 2, 2017

(54) LANDING GEAR AERO SKIRT

(71) Applicant: WABASH NATIONAL, L.P., Lafayette, IN (US)

(72) Inventors: Leonard W. Baker, Lafayette, IN (US); Brian N. Haan, Lafayette, IN (US); James A. Sweet, Lafayette, IN (US); Michael J. Courtney, Dayton, IN (US)

(21) Appl. No.: 15/252,377

(22) Filed: Aug. 31, 2016

Related U.S. Application Data
(60) Provisional application No. 62/212,099, filed on Aug. 31, 2015.

(51) Int. Cl. B62D 35/00; B62D 35/02

(52) U.S. Cl. CPC B62D 35/001; B62D 35/02

(57) ABSTRACT

A trailer with an aerodynamic skirt system for reducing drag is disclosed. The aerodynamic skirt system may include a landing gear skirt with an aperture positioned to receive a landing gear crank handle. The aerodynamic skirt system extends down from the sides of the trailer.

### CROSS-REFERENCE TO RELATED APPLICATIONS

The present utility patent application claims the benefit of U.S. Provisional Application No. 62/212,099, filed on Aug. 31, 2015, and entitled “Landing Gear Aero Skirt.” The entire disclosure thereof is incorporated by reference herein in its entirety.

### FIELD OF THE INVENTION

The present invention relates generally to vehicles and trailers for vehicles. In particular, the present invention relates to aerodynamic trailers with skirt systems, for example.

### BACKGROUND

To reduce wind flow resistance and drag on a semi-trailer truck, trailer, a pup trailer, tractor, semitrailer, or other vehicle, aerodynamic devices may be used to redirect and control the flow of air passing around the vehicle. During operation of a tractor-trailer truck, air around the tractor-trailer truck may flow between the tractor unit and the trailer and impart a drag force to the trailer. Aerodynamic devices are designed to control the air flowing into the gap formed between the tractor unit and the trailer and under underneath the tractor and trailer. Such reduction on the drag of the vehicle may conserve fossil fuels, as well as other sources of vehicle drive power for hybrid vehicles, battery-operated vehicles, and alternative fuel-based vehicles, for example.

### SUMMARY

The present disclosure may comprise one or more of the following features and combinations thereof.

According to the present disclosure, a skirt system for a trailer may comprise a left landing gear skirt configured to be attached to a left side of a floor of a trailer, a right landing gear skirt configured to be attached to a right side of the floor of a trailer, and an aperture formed within one of the left and right landing gear skirts, the aperture configured for insertion of a landing gear crank handle.

According to the present disclosure, a trailer may comprise a floor having a front side, a back side, a left side and a right side, a rear wheel assembly coupled to the floor, and/or a landing gear coupled to the floor between the rear wheel assembly and the front side of the floor, the landing gear including at least one support leg moveable from a stowed position to a use position. The trailer may further comprise a skirt system including a left landing gear skirt and a left side skirt that extend downwardly from and along the left side of the floor, and a right landing gear skirt and a right side skirt that extend downwardly from and along the right side of the floor, wherein the landing gear may be located entirely within a footprint of the skirt system when the trailer is viewed from the left side or the right side of the trailer.

According to the present disclosure, a method of installing a skirt system to a trailer may comprise the steps of coupling a skirt system to a floor of a trailer, the skirt system including a left landing gear skirt that extends downwardly from and along a left side of the floor, and a right landing gear skirt that extends downwardly from and along a right side of the floor and positioning a crank handle extending from landing gear attached to a bottom of the trailer within an aperture formed within one of the left and right landing gear skirts.

These and other features of the present disclosure will become more apparent from the following description of the illustrative embodiments.

### BRIEF DESCRIPTION OF THE DRAWINGS

FIG. 1 is a perspective view of a tractor, two pup trailers with landing gear skirts, and side skirts coupled to the pup trailers between the rear wheel assemblies and the front of the pup trailers;

FIG. 2 is a side elevation view of the exterior of the landing gear skirt of FIG. 1;

FIG. 3 is a side elevation view of the exterior of the side skirt of FIG. 1;

FIG. 4 is a side elevation view of the interior of the side skirt of FIG. 3;

FIG. 5 is a side elevation view of the interior of the landing gear skirt of FIG. 2;

FIG. 6 is an elevation view of a mount bracket assembly that attaches the skirt system to the floor of the trailer;

FIG. 7 is a perspective view of another embodiment of the skirt system including a landing gear skirt, a side skirt, a wheel assembly skirt, and a rear skirt all connected continuously to one another and coupled to the trailer;

FIG. 8A is a side elevation view of the exterior of the landing gear skirt and the side skirt of the skirt system of FIG. 7, and showing that the landing gear skirt includes an aperture for a landing gear handle;

FIG. 8B is a side elevation view of the exterior of the rear wheel assembly skirt and the rear skirt of the skirt system of FIG. 7;

FIG. 9A is a side elevation view of the interior of the landing gear skirt and the side skirt of the skirt system of FIG. 7, and showing that the landing gear skirt includes an aperture for a landing gear handle;

FIG. 9B is a side elevation view of the interior of the rear wheel assembly skirt and the rear skirt of the skirt system of FIG. 7;

FIG. 10 is a perspective view of another embodiment of an skirt system showing a landing gear skirt that overlaps a side skirt coupled to the trailer;

FIG. 11 is a side elevation view of the exterior of the side skirt of FIG. 10;

FIG. 12 is a side elevation view of the interior of the side skirt of FIG. 10;

FIG. 13 is a side elevation view of the exterior of the landing gear skirt of FIG. 10;

FIG. 14 is a side elevation view of the interior of the landing gear skirt of FIG. 10;

FIG. 15 is a top plan view of the skirt system of FIG. 10 showing the left and right skirt systems, and showing the rear edge of the landing gear skirt overlapping the forward edge of the side skirt;

FIG. 16 is a perspective view of another embodiment of an skirt system showing a landing gear skirt, and a spaced apart side skirt coupled to the trailer;

FIG. 17 is a side elevation view of the exterior of the side skirt of FIG. 16;

FIG. 18 is a top plan view of the left and right sides of the skirt system showing the landing gear skirts and side skirts of FIG. 16;

FIG. 19 is a side elevation view of the exterior of a landing gear skirt;

FIG. 20 is a side elevation view of the interior of the landing gear skirt of FIG. 19 showing a landing gear bracket;

FIG. 21 is a top plan view of the landing gear skirt of FIG. 19;

FIG. 22 is a top plan view of the landing gear skirt of FIG. 19 coupling to a landing gear support leg; and

FIG. 23 is a top plan view of the left and right side landing gear skirts of FIG. 19 on a trailer.

### DETAILED DESCRIPTION

For the purposes of promoting an understanding of the principles of the invention, reference will now be made to a number of illustrative embodiments shown in the attached drawings and specific language will be used to describe the same. While the concepts of this disclosure are described in relation to a trailer for a tractor, it will be understood that that they are equally applicable to other trailers generally, and more specifically to pup trailers, conventional flat-bed and/or box or van type trailers, examples of which include, but should not be limited to, straight truck bodies, small personal and/or commercial trailers and the like.

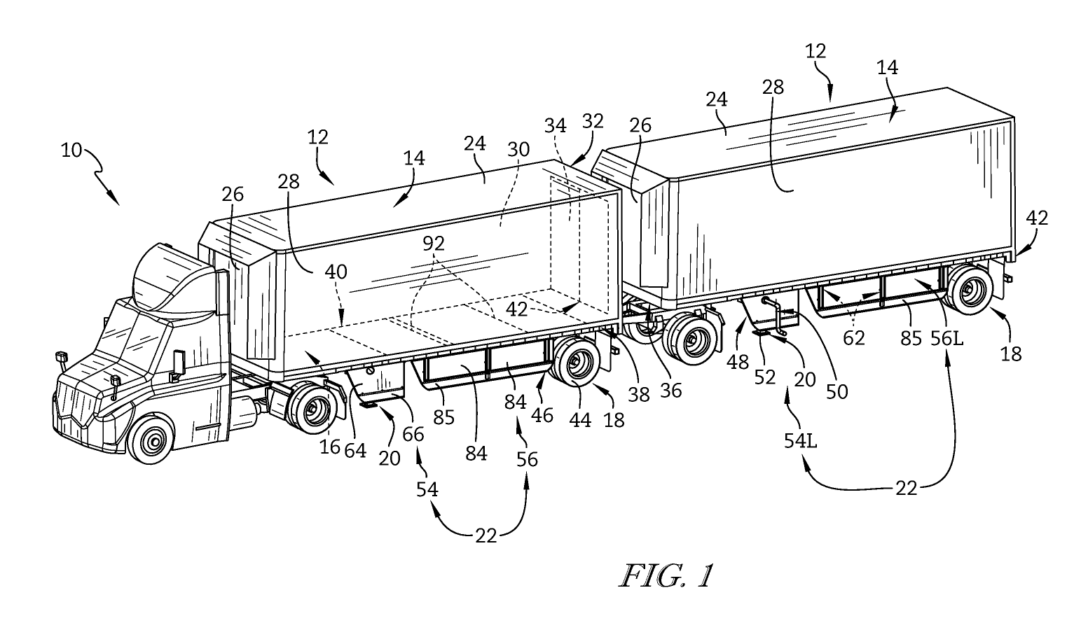

A tractor 10 can be coupled to one or more trailers 12 for transporting goods along a roadway as shown in FIG. 1. A trailer 12 can have a container 14, a floor 16, a rear wheel assembly 18, a landing gear 20, and a skirt system 22 as shown in FIG. 1. The skirt system 22 is coupled to the floor 16 and is configured to redirect air and improve fuel efficiency of the tractor 10 when transporting goods.

The container 14 of the trailer 12 can have a roof 24, a front wall 26, a left wall 28, a right wall 30, and a rear frame assembly 32, as shown in FIG. 1. The rear frame assembly 32 may include a rear frame and one or more doors 34, for example, swing doors or an overhead door, to allow access to the interior of container 14.

The floor 16 of the trailer 12 has a front side 36, a left side 38, a right side 40, a back side 42, and a plurality of cross-members 92 of the floor 16, as shown in FIG. 1. The floor 16 is included in an embodiment of trailer 12 in which the floor 16 supports container 14. Alternatively, the trailer 12 can be a flat-bed trailer that does not include the container 14.

The rear wheel assembly 18 is coupled to the floor 16 near the back side 42 of the floor 16, as shown in FIG. 1. The rear wheel assembly 18 includes wheels 44 and an axle 46 that support the rear of the trailer 12 when the trailer 12 is being pulled by tractor 10, and when the trailer 12 is stationary and disconnected from the tractor 10.

The landing gear 20 is coupled to the floor 16 between the rear wheel assembly 18 and the front side 36 of the floor 16, as shown in FIG. 1. The landing gear 20 includes at least one support leg 48, a crank handle 50, and may contain a landing gear foot 52. The support leg 48 can extend down from the floor 16 to a surface to support the trailer 12 when not connected to the tractor 10, or can be retracted when connected to the tractor 10. The support leg 48 of the landing gear 20 can be extended or retracted using the crank handle 50.

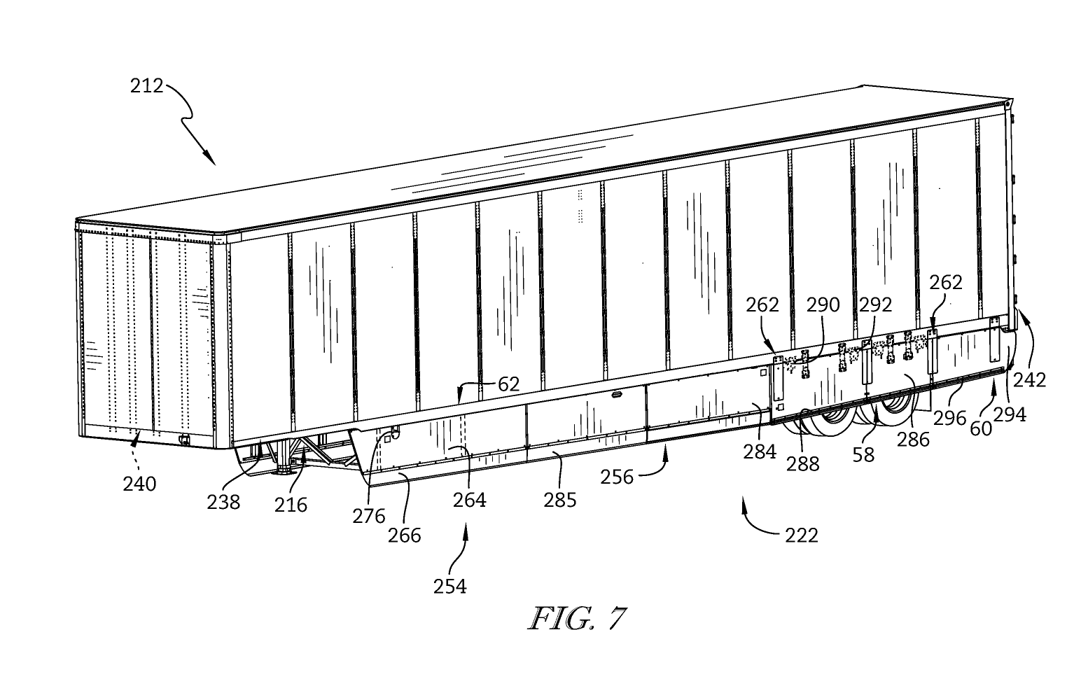

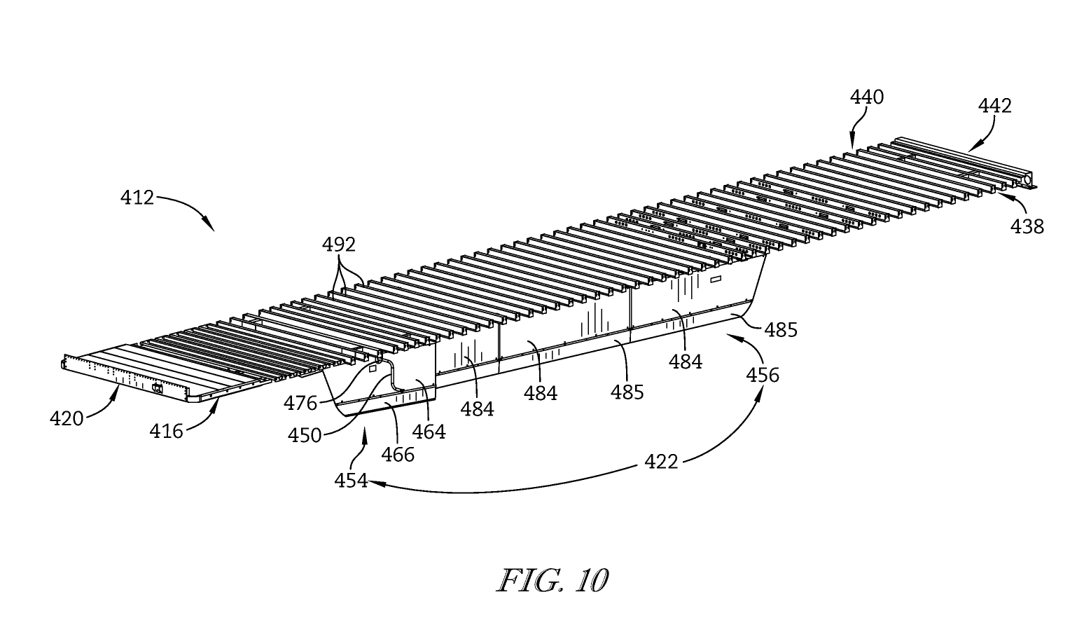

To improve the air flow and fuel efficiency of the tractor 10 when pulling a trailer 12, the trailer 12 can include an aerodynamic skirt system 22, as shown in FIG. 1. Illustratively, a skirt system 22 can include any combination of a landing gear skirt 54, a side skirt 56, a rear wheel assembly skirt 58, and a rear skirt 60. In an illustrative embodiment, a skirt system 22 includes a landing gear skirt 54 and side skirt 56, as shown in FIG. 1. In another illustrative embodiment, a skirt system 222 includes a landing gear skirt 254, a side skirt 256, a rear wheel assembly skirt 58, and a rear skirt 60, as shown in FIG. 7. In another illustrative embodiment, a skirt system 322 includes a landing gear skirt 354, a side skirt 356, and a rear skirt 360, as shown in FIG. 10. In another illustrative embodiment, a skirt system 422 includes a landing gear skirt 454 and a side skirt 456, as shown in FIG. 14. In yet another illustrative embodiment, a skirt system 522 includes a landing gear skirt 554 and a side skirt 556, as shown in FIG. 20.

The skirt system 22 can be coupled to the trailer 12 along the left side 38 or the right side 40 of the floor 16, or both the left side 38 and the right side 40, as shown in FIG. 1. In an embodiment, the skirt system 22 is configured to be coupled rigidly to the left side 38 or the right side 40 of the floor 16. Illustratively, the skirt system 22 is attached to the left side 38 and the right side 40 of the floor 16 with mount bracket assemblies 62, as shown in FIGS. 1-5. Attaching the skirt system 22 with mount bracket assemblies 62 can allow the skirt system 22 to tilt if contacted by an object to reduce stress on the skirt system 22, or the object, as discussed below.

The landing gear skirt 54 of the skirt system 22 may improve fuel economy by deflecting air away from the front side 36 of the trailer 12 and allow the flow to attach to the side skirt 56 quicker. The landing gear skirt 54 is coupled to the floor 16 of the trailer, as shown in FIG. 1. The landing gear skirt 54 includes a wall panel 64, mount bracket assemblies 62 for coupling the wall panel 64 to the floor 16, and a flexible bottom flap 66 coupled to the wall panel 64, as shown in FIGS. 2 and 5. The flexible bottom flap 66 is configured to attach to the wall panel 64, as shown in FIGS. 2 and 5, and provides a protective edge, as discussed below.

The wall panel 64 includes a top edge 68, a forward edge 70, a bottom edge 72, and a rear edge 74, as shown in FIGS. 2 and 5. In an embodiment, the rear edge 74 extends generally perpendicular to the floor 16 of the trailer 12, and the forward edge 70 extends generally non-perpendicular to the floor of the trailer. Illustratively, the top edge 68 can have a length longer than the length of the bottom edge 72 so that the forward edge 70 is angled as, shown in FIGS. 2 and 5.

The wall panel 64 of the landing gear skirt 54 can be made from a composite material, or from a metal. For example, the composite material may include a plastic core and metal outer skins coupled to the plastic core. Such a composite material provides a rigid, but lightweight and durable material. For example, each wall panel 64 may be made of a DURAPLATE® composite panel provided by Wabash National Corporation of Lafayette, Ind. DURAPLATE® composite panels are constructed of a high-density polyethylene plastic core bonded between two high-strength steel skins. For another example, the skirt system 22 can be made of a glass reinforced thermoplastic composite. It should be understood that other suitable composite materials may be used as well. Further, the wall panels 64 may be of any number of suitable, non-composite materials such as metals, metal alloys, and/or plastics, for example.

The flexible bottom flap 66 extends downwardly from the wall panel 64 of the landing gear skirt 54 to provide a less stiff strip along the bottom side 72 of wall panel 64, as shown in FIGS. 2 and 5. The flexible bottom flap 66 is configured to be coupled along the bottom side 72 of wall panel 64 along the entire length of wall panel 64. Illustratively, the flexible bottom flap 66 is made of plastic or rubber. However, other suitable materials may be used as well. The flexible bottom flap 66 further operates to resist airflow and may prevent damage to the wall panel 64 from forces applied vertically such as in situations where the trailer 12 may traverse over a curb or railroad track where the road surface is not flat. In such instances, for example, the flexible bottom flap 66 is configured to bend, or flex to prevent damage to the wall panel 64.

The wall panel 64 of the landing gear skirt 54 may optionally be formed to include an aperture 76 sized to allow passage of a landing gear crank handle 50, as shown in FIGS. 2 and 5. The aperture 76 may be included in the right landing gear skirt 54R or the left landing gear skirt 54L, or illustratively may be included in both the left landing gear skirt 54L and in the right landing gear skirt 54R. Illustratively, the aperture 76 may not be included either in the left landing gear skirt 54L or the right landing gear skirt 54R. The aperture 76 may be arranged along a top side of the wall panel 64 adjacent to the floor 16 of the trailer 12, as shown in FIGS. 2 and 5.

The landing gear skirt 54 can be coupled to the floor 16 as to be parallel with either the left side 38 or the right 40 side of the floor 16 of the trailer 12. Alternatively, the landing gear skirt 54 can be non-parallel with the either the right side 40 or the left side 38 of floor 16 of the trailer 12, as shown in FIG. 1. Illustratively, the left landing gear skirt 54L has a front edge 78 facing the front side 36 of the floor 16 and a back edge 80 facing the back side 42 of the floor 16, as shown in FIGS. 2 and 5. The left landing gear skirt 54L is angled relative to the floor so that front edge 78 of the left landing gear skirt 54L is closer to the right side 40 of the floor 16 than the back edge 80 of the left landing gear skirt 54L. Orienting the landing gear skirt 54 in such a manner may lead to improved uptake of the air flow from underneath the trailer 12.

The skirt system 22 includes a left side skirt 56L and a right side skirt 56R, as shown in FIG. 1. The left side skirt 56L extends downwardly from and is located along the left side 38 of the floor 16 between the left landing gear skirt 54L and the rear wheel assembly 18, as shown in FIG. 1. The right side skirt 56R extends downwardly from and is located along the right side 40 of the floor 16 between the right landing gear skirt 54R and the rear wheel assembly 18. It should be understood that the trailer 12 has both a right skirt system 22R and a left skirt system 22L that are identical in configuration and function, even if only a single side is being described.

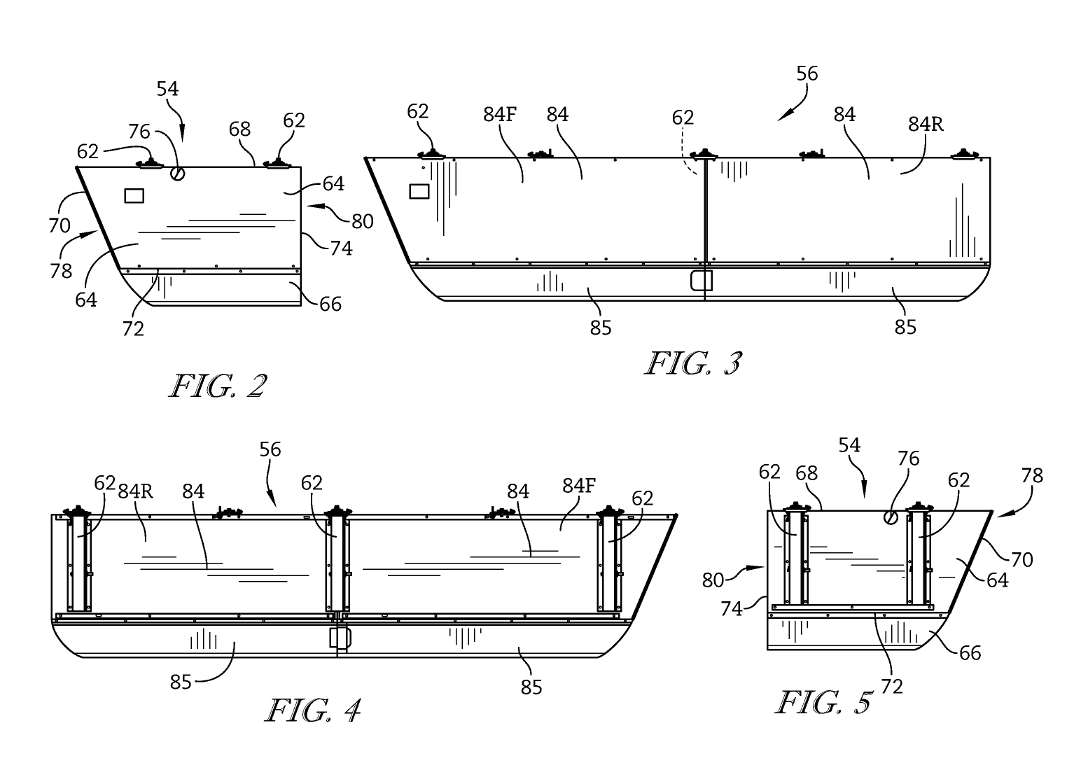

As shown in FIGS. 1-5, the skirt system 22 includes a side skirt 56 having two wall panels 84 coupled to each other, mount bracket assemblies 62, and a flexible bottom flap 85. The wall panels 84 are secured to each other and to the trailer 12 by mount bracket assemblies 62. Illustratively, a first mount bracket assembly 62 is positioned to couple the forward wall panel 84F to the floor 16, as shown in FIGS. 3 and 4. A second mount bracket assembly 62 is positioned between and coupled to the forward wall panel 84F and the rear wall panel 84R to couple the two wall panels 84F, 84R to each other and to the floor 16. A third mount bracket assembly 62 is coupled to the rear wall panel 84R to secure the wall panel 84R to the floor 16 of the trailer 12. Illustratively, while the side skirt 56 includes three mount bracket assemblies 62 and two wall panels 84F, 84R, it is within the scope of this disclosure to provide a side skirt 56 having any number of mount bracket assemblies 62 and any number of wall panels 84. Further, it is within the scope of this disclosure for the side skirt 22 to include a single, unitary wall panel 84. The flexible bottom flap 85 of the side skirt 56 is similar to the flexible bottom flap 66 of the landing gear skirt 54. Illustratively, the wall panels 84F and 84R can each have a flexible bottom flap 85 coupled by a bracket 87, or alternatively can share a single flexible bottom flap 85.

As is discussed in greater detail below, the mount bracket assembly 62 is configured to couple the wall panels 64, 84 of the skirt system 22 to the floor 16 of the trailer 12, as shown in FIGS. 2-5. Furthermore, the mount bracket assembly 62 allows the skirt system 22 to tilt laterally both inwardly and outwardly relative to the floor 16 of the trailer 12. The ability of the wall panels 64, 84 to tilt bi-laterally relative to the cross-member 92 (i.e., to tilt both inwardly and outwardly relative to the cross-member 92) allows the wall panels 64, 84 to potentially avoid damage when the trailer 12 traverses into or over a fixed, immovable obstacle, for example, and thus runs laterally into the obstacle, for example. It should also be understood, however, that the skirt system 22 may be sufficiently rigidly mounted to the floor such that the skirt system 22 is generally prevented from tilting under normal wind and road air forces.

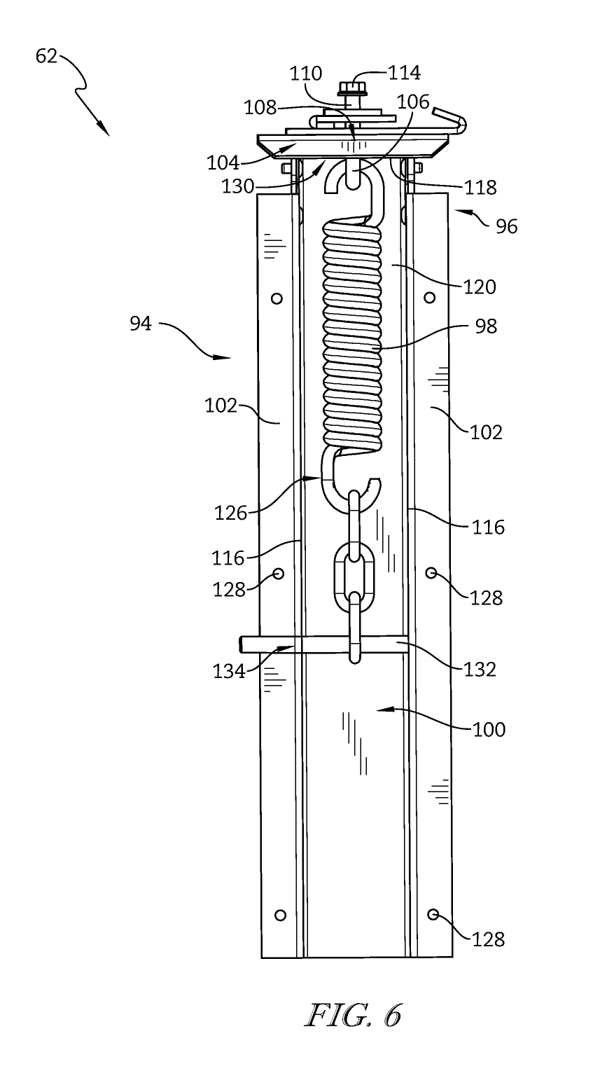

Each mount bracket assembly 62 is coupled to a cross-member 92 of the floor 16 of the trailer 12, as shown in FIG. 1. Illustratively, each mount bracket assembly 62 includes a channel mount 94 configured to be coupled to a single or adjacent wall panels 64, 84, a mount plate 96, and a spring 98, as shown in FIGS. 1-5. As shown in FIG. 6, the mount plate 96 includes a base wall 100 and two side flanges 102 coupled to and angled downwardly from each side of the mount base 104. Illustratively, the mount plate 96 is coupled to the cross-member 92 by a U-bolt 106 received through two apertures 108 formed in the mount base 104 of the mount plate 96. The U-bolt 106 has threaded ends 110 which are each received through a respective aperture of the cross-member 92. Nuts 114 are threaded onto the threaded ends 110 to secure the U-bolt 106 and the mount plate 96 to the cross-member 92. Illustratively, while a U-bolt is shown and described herein, it is also within the scope of this disclosure to use an eye bolt or any other suitable fastener onto which the spring 98 may be coupled. The mount bracket assembly 62 and other alternative mounting brackets are described in more detail in U.S. Pat. No. 8,177,286, owned by the assignee of the present application, the disclosure of which is incorporated herein by reference in its entirety.

The channel mount 94 of the mount bracket assembly 62 includes spaced-apart side walls 116, a top wall 118 coupled to each side wall 116, a rear wall 120 including side flanges 122 extending outwardly therefrom, and a front wall 124 coupled to each side wall 116, as shown in FIG. 6. Illustratively, the side walls 116, front wall 124, and rear wall 120 cooperate to define a passageway 126 therebetween. While the channel mount 94 is shown to include the front wall 124, it is within the scope of this disclosure to include a channel mount lacking such a front wall in order to gain access to the spring 98 positioned within the passageway 126. Illustratively, each side flange 122 includes a plurality of apertures 128 formed therein, as shown in FIGS. 3, 4 and 6. Each aperture 128 is configured to receive a fastener (not shown) such as a bolt, rivet, screw, or any other suitable fastener, for example, in order to couple the channel mount 94 to the wall panels 64, 84. The top wall 118 of the channel mount 94 includes an aperture 130 configured to receive the U-shaped portion of the U-bolt 106 therein. A bolt 132 is received through an aperture 134 formed in each side wall 116 of the channel mount 94. The bolt 132 is secured to the channel mount 94 such that the bolt 132 extends horizontally across the passageway 126 of the channel mount 94. As shown in FIG. 6, the bolt 132 is positioned below and spaced-apart from the top wall 118 of the channel mount 94. Illustratively, the bolt 132 operates as a bridge or an arm extending between and coupled to each of the side walls 116 of the channel mount 94. Illustratively, it should be understood that any suitable structure may be positioned between and coupled to one or more of the side walls 116 in order to provide an anchor for the spring 98, as discussed below.

The spring 98 is coupled at a first, upper end to the U-shaped portion of the U-bolt 106 while a second, lower end of the spring 98 is coupled to the bolt 132. In use, therefore, the mount bracket assembly 62 is tiltable relative to the cross-member 92 of the floor 16 of the trailer 12. In particular, the channel mount 94, including the spring 98 and the bolt 132, is laterally tiltable relative to the cross-member 92 while the U-bolt 106 and the mount plate 96 remain generally stationary with the cross-member 92. The channel mount 94 and the wall panel 84 mounted thereto are laterally tiltable outwardly in a direction away from the trailer 12 and inwardly in a direction toward the floor 16 of the trailer 12. Illustratively, the side flanges 102 of the mount plate 96 operate as a stop to prevent further tilting movement of the channel mount 94 relative to the mount plate 96 in both the outward and the inward directions. Further illustratively, the channel mount 94 is configured to tilt approximately 30 degrees outwardly and 30 degrees inwardly relative to its vertical position. However, it is within the scope of this disclosure to provide a channel mount 94 configured to tilt relative to the cross-member 92 of the trailer 12 any suitable degree.

In another embodiment, a skirt system 222 includes a continuously connected landing gear skirt 254, a side skirt 256, a rear wheel assembly skirt 58, and a rear skirt 60, as shown in FIGS. 7-9. The skirt system 222 can be coupled to a floor 216 of a trailer 212 using mount bracket assemblies 62, 262.

Illustratively, the landing gear skirt 254 includes an aperture 276 that is sized for a crank handle 250, three wall panels 264, mount bracket assemblies 62 to couple the wall panels 264 to each other and to the floor 216, and a single flexible bottom flap 266, as shown in FIG. 7. The wall panels 264 and the flexible bottom flaps 266 of the landing gear skirt 254 are similar the corresponding parts in landing gear skirt 54.

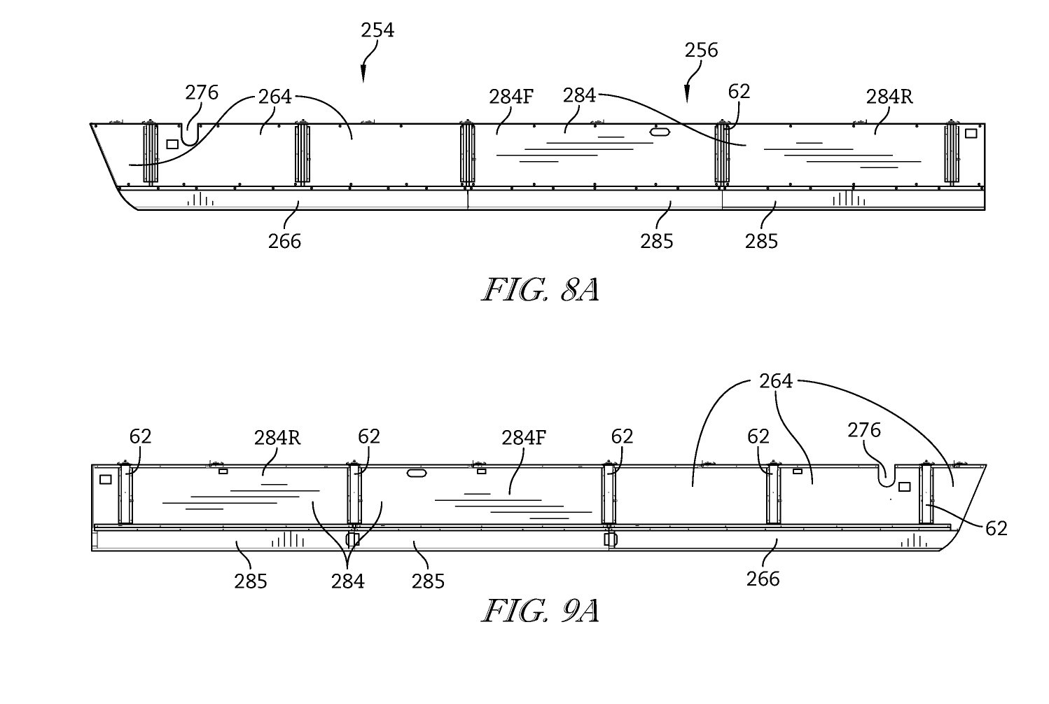

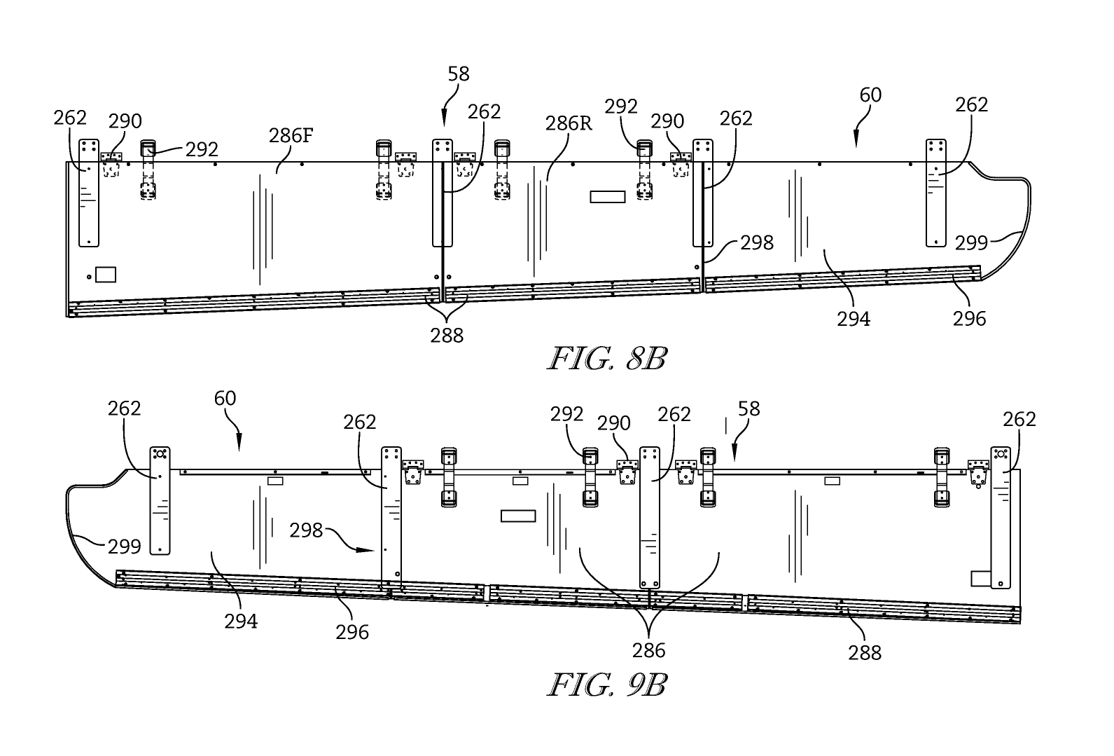

The landing gear skirt 254 is coupled to the side skirt 256 by mount bracket assemblies 62 to form the continuously connected skirt system 222, as shown in FIGS. 7, 8A, and 9A. The side skirt 256 includes wall panels 284, mount bracket assemblies 62 that connects the wall panels 284 to the floor 216, and flexible bottom flaps 285. Illustratively, the side skirt 256 can have two wall panels 284F, 284R coupled to each other, as shown in FIGS. 8A and 9A. The wall panels 284F, 284R are secured to each other and to the trailer 212 by a mount bracket assembly 62 in a similar fashion to the side skirt 56, as shown in FIG. 7. Illustratively, a first mount bracket assembly 62 is positioned to couple the forward wall panel 284F to the floor 216 and to landing gear skirt 254. Illustratively, a second mount bracket assembly 62 is positioned between and coupled to the forward and the rear wall panels 284F, 284R to couple the two wall panels 284F, 284R to each other and to the floor 216. A third mount bracket assembly 62 is coupled to the rear wall panel 284R to secure the wall panel 284R to the floor 216 of the trailer 212. Illustratively, while the side skirt 256 includes three mount bracket assemblies 62 and two wall panels 284, it is within the scope of this disclosure to provide a side skirt 256 having any number of mount bracket assemblies 62 and any number of wall panels 284.

The rear wheel assembly skirt 58 includes wall panels 286, mount bracket assemblies 262 for coupling the wall panels 286 to the floor 216, and bottom strips 288, as shown in FIG. 7. The rear wheel assembly skirt 58 extends downwardly from the floor 216 and along the left side 238 or the right side 240 of the floor 216. Illustratively, the rear wheel assembly skirt 58 is located between the back side 242 of the floor 216 and the side skirt 256, and locates the rear wheel assembly 218 within a footprint of the left wheel assembly skirt 58L and the right wheel assembly skirt 58R when the trailer is viewed from the left side or the right side of the trailer. In illustrative embodiments, the rear wheel assembly skirt 58 extends all the way to the back side 242 of the floor 216. Illustratively, the rear wheel assembly skirt 58 can be coupled to the side skirt 256 or may not be coupled to side skirt 256.

Illustratively, the rear wheel assembly skirt 58 can have two wall panels 286F, 286R coupled to each other as shown in FIGS. 88 and 98. The wall panels 286F, 286R are secured to each other and to the trailer 212 by mount bracket assemblies 262. The mount bracket assembly 262 is positioned to couple the forward wall panel 286F to the floor 216 and is comprised of a stiff metal plate. Illustratively, the mount bracket assembly 262 is positioned between and coupled to the forward and the rear wall panels 286F, 286R to couple the two wall panels 286F, 286R to each other and to the floor 216. A third mount bracket assembly 262 is coupled to the rear wall panel 286R to secure the rear wall panel 286R to the floor 216 of the trailer 212, and optionally to the rear skirt 60 as shown in FIGS. 8B and 9B. Illustratively, the rear wheel assembly skirt includes hinges 290 and tethers 292 that couple the wall panels 286 to the floor 16 as shown in FIGS. 8B and 9B. The hinges 292 allow pivoting of the wall panels 286 relative to the floor 216 of the trailer 212. The tethers 292 provide an additional attachment point of the wall panels 286 to the floor 216 of the trailer 212. Illustratively, the bottom strip 288 is similar in composition and function to the flexible bottom flaps 266, 285 of the landing gear skirt 254 and side skirt 256. Illustratively, while the rear wheel assembly skirt 58 includes three mount bracket assemblies 262 and two wall panels 286F, 286R, it is within the scope of this disclosure to provide a rear wheel assembly skirt 58 having any number of mount bracket assemblies 262 and any number of wall panels 286.

The rear skirt 60 includes a wall panel 294, mount bracket assemblies 262 for coupling the wall panel 294 to the floor 216, and a bottom strip 296 as shown in FIGS. 7, 8B, and 9B. The rear skirt 60 extends downwardly from the floor 216 and along the left side 238 or the right side 240 of the floor 216 and is located between the back side 242 of the floor 216 and the rear wheel assembly skirt 58. Illustratively, the rear skirt 60 can be coupled to the rear wheel assembly skirt 58 with a mount bracket assembly 262.

The wall panel 294 of the rear skirt 60 includes a forward edge 298 and a rear edge 299 as shown in FIGS. 7, 8B, and 9B. Illustratively, the forward edge 298 extends down from the floor 216 and is generally perpendicular to floor 216, and the rear edge 299 can be straight, or alternatively, can be curved to provide additional aerodynamic properties to the trailer 212.

In another embodiment, a skirt system 422 includes a landing gear skirt 454, mount bracket assemblies 62, and a side skirt 456, as shown in FIGS. 10-15. The skirt system 422 can be coupled to a floor 416 of a trailer 412 using mount bracket assemblies 62 to improve the airflow around the trailer 412.

Illustratively, the landing gear skirt 454 includes an aperture 476 that is sized for a crank handle 450, a wall panel 464, mount bracket assemblies 62 to couple the wall panel 464 to the floor 416, and a flexible bottom flap 466, as shown in FIGS. 10, 13 and 14. The landing gear skirt 454 can be coupled to the floor 416 as to be parallel with either the left side 438 or the right 440 side of the floor 416 of the trailer 412. Alternatively, the landing gear skirt 454 can be non-parallel with the either the right side 440 or the left side 438 of floor 416 of the trailer 412, as shown in FIG. 15. Illustratively, the left landing gear skirt 454L has a front edge 478L facing the front side 436 of the floor 416 and a back edge 480L facing the back side 442 of the floor 416. The left landing gear skirt 454L is angled relative to the floor so that front edge 478 of the left landing gear skirt 454L is closer to the right side 440 of the floor 416 than the back edge 480 of the left landing gear skirt 454L. Orienting the landing gear skirt 454 in such a manner may lead to improved uptake of the air flow from underneath the trailer 412.

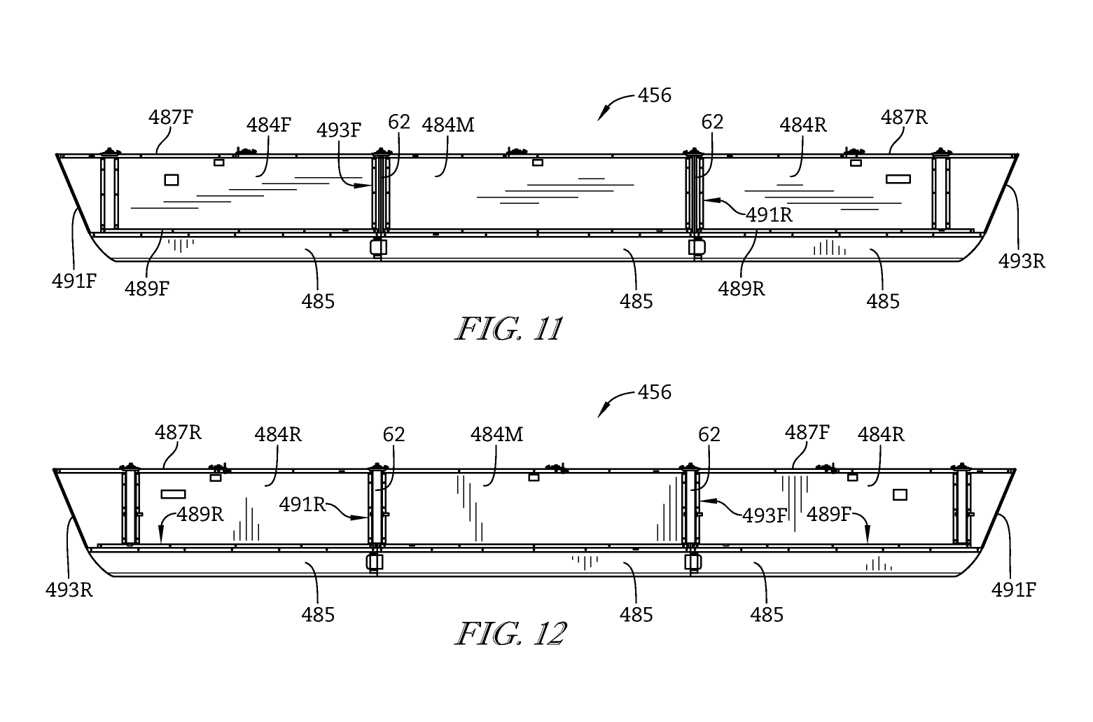

The side skirt 456 includes wall panels 484, mount bracket assemblies 62 that couple the wall panels 484 to the floor 416, and a flexible bottom flap 485 that is coupled to the wall panel 484, as shown in FIGS. 10-12. Illustratively, the side skirt 456 can have three wall panels 484F, 484M, 484R coupled to each other, as shown in FIGS. 11 and 12. The wall panels 484F, 484M, 484R are secured to each other and to the trailer 412 by the mount bracket assemblies 62 in a similar fashion to the side skirt 56. Illustratively, a first mount bracket assembly 62 is positioned to couple the forward wall panel 484F to the floor 416, as shown in FIG. 11. Illustratively, a second mount bracket assembly 62 is positioned between the forward and the middle wall panels 484F, 484M to couple the two wall panels 484F, 484M to each other and to the floor 416. A third mount bracket assembly 62 is positioned between the middle and the rear wall panels 484M, 484R to couple the two wall panels 484M, 484R to each other and to the floor 416. A fourth mount bracket assembly 62 is coupled to the rear wall panel 484R to secure the wall panel 484R to the floor 416 of the trailer 412. Illustratively, while the side skirt 456 includes four mount bracket assemblies 62 and three wall panels 484F, 484M, 484R it is within the scope of this disclosure to provide a side skirt 456 having any number of mount bracket assemblies 62 and any number of wall panels 484. The flexible bottom flap 485 of the side skirt 456 is similar to the flexible bottom flap 66 of the landing gear skirt 54. Illustratively, the wall panels 484F, 484M, 484R can each have a flexible bottom flap 485.

The forward wall panel 484F includes a top edge 487F, a bottom edge 489F, a forward edge 491F and a rear edge 493F, as shown in FIGS. 11 and 12. Illustratively, the top edge 487F has a first length and the bottom edge 489F has a shorter second length so that the forward edge 491F is non-perpendicular to the floor 416, and the rear edge 493F is generally perpendicular to the floor 416, as shown in FIGS. 11 and 12. The rear wall panel 484R includes a top edge 487R, a bottom edge 489R, a forward edge 491 R, and a rear edge 493R. Illustratively, the top edge 487R has a first length and the bottom edge 489R has a shorter second length so that the rear edge 493R is non-perpendicular to the floor 416 and the forward edge 491F is generally perpendicular to the floor 416, as shown in FIGS. 11 and 12.

The side skirt 456 can be non-parallel with the either the right side 440 or the left side 438 of floor 416 of the trailer 412. Illustratively, the left side skirt 456L has a front edge 495L facing the front side 436 of the floor 416 and a rear edge 497L facing the back side 442 of the floor 416, as shown in FIG. 15. The left side skirt 456L is angled relative to the floor so that front edge 495 of the left side skirt 456L is closer to the right side 440 of the floor 416 than the rear edge 497L of the left side skirt 456L, as shown in FIGS. 10 and 15. The right side skirt 456R is oriented in an equivalent manner. Illustratively, the front edge 495L of the left side skirt 456L is located between the front side 436 of the floor 416 and the back edge 480 of the landing gear skirt 454, and is angled to be nearer the left side 438 of the floor 416 than the landing gear skirt 454, as shown in FIGS. 10 and 15.

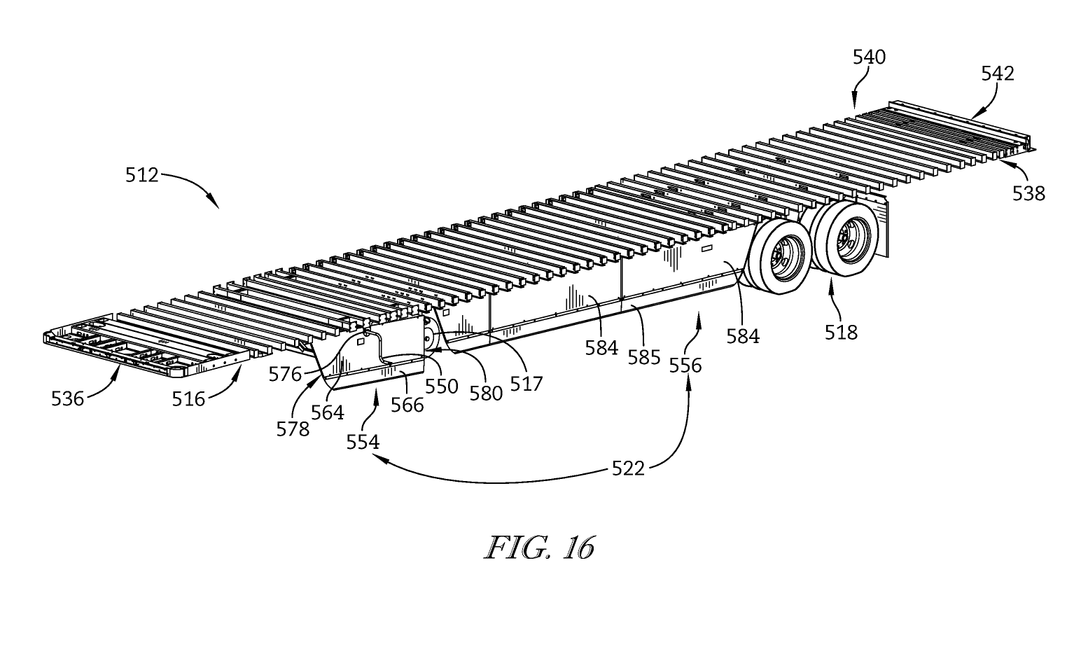

In another embodiment, a skirt system 522 includes a landing gear skirt 554, mount bracket assemblies 62, and a spaced-apart side skirt 556, as shown in FIGS. 16-18. The skirt system 522 can be coupled to a floor 516 of a trailer 512 using the mount bracket assemblies 62 to improve the airflow around the trailer 512.

Illustratively, the landing gear skirt 554 includes an aperture 576 that is sized for a crank handle 550, wall panel 564, mount bracket assemblies 62 to couple the wall panel 564 to the floor 516, and a flexible bottom flap 566, as shown in FIG. 16. The landing gear skirt 554 can be coupled to the floor 516 as to be parallel with either the left side 538 or the right 540 side of the floor 516 of the trailer 512. Alternatively, the landing gear skirt 554 can be non-parallel with the either the right side 540 or the left side 538 of floor 516 of the trailer 512, as shown in FIGS. 16 and 18. Illustratively, the left landing gear skirt 554L has a front edge 578 facing the front side 536 of the floor 516 and a back edge 580 facing the back side 542 of the floor 516. The left landing gear skirt 564L is angled relative to the floor so that front edge 578 of the left landing gear skirt 554L is closer to the right side 540 of the floor 516 than the back edge 580 of the left landing gear skirt 554L, as shown in FIGS. 16 and 18. Orienting the landing gear skirt 554 in such a manner may lead to improved uptake of the air flow from underneath the trailer 512.

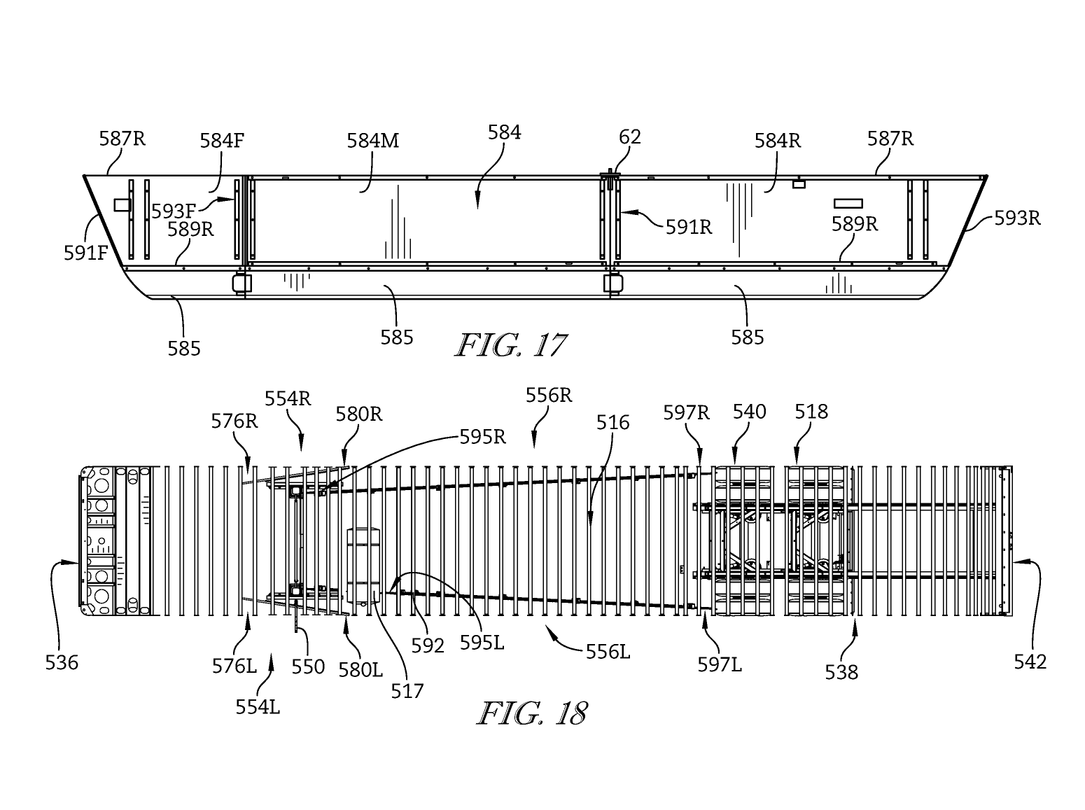

The side skirt 556 includes wall panels 584, mount bracket assemblies 62 that couple the wall panels 584 to the floor 516, and a flexible bottom flap 585 that is coupled to the wall panels 584, as shown in FIGS. 16-18. Illustratively, the side skirt 556 can have three wall panels 584F, 584M, 584R coupled to each other, as shown in FIGS. 16 and 17. The wall panels 584F, 584M, 584R are secured to each other and to the trailer 512 by a mount bracket assembly 62 in a similar fashion to the side skirt 56. Illustratively, a first mount bracket assembly 62 is positioned to couple the forward wall panel 584F to the floor 416. Illustratively, a second mount bracket assembly 62 is positioned between the forward and the middle wall panels 584F, 584M to couple the two wall panels 584F, 584M to each other and to the floor 516. A third mount bracket assembly 62 is positioned between the middle and the rear wall panels 584M, 584R to couple the two wall panels 584M, 584R to each other and to the floor 516. A fourth mount bracket assembly 62 is coupled to the rear wall panel 584R to secure the wall panel 584R to the floor 516 of the trailer 512. Illustratively, while the side skirt 556 includes four mount bracket assemblies 62 and three wall panels 584F, 584M, 584R, it is within the scope of this disclosure to provide a side skirt 556 having any number of mount bracket assemblies 62 and any number of wall panels 584. The flexible bottom flap 585 of the side skirt 556 is similar to the flexible bottom flap 66 of the landing gear skirt 54. Illustratively, the wall panels 584F, 584M, 584R can each have a flexible bottom flap 585, or may share a single flexible bottom flap 585. In an embodiment the three wall panels 584F, 584M, 584R are similar in length, and in another embodiment they each have a different length as to allow access to fluid tank 517. The embodiment of FIGS. 16-18 is similar to the embodiment of FIGS. 10-15, with one of the main differences being a gap formed between one or both of the landing gear skirts 554L, 554R and a respective side skirt 556L, 556R, as best seen in FIG. 18. The gap allows for access to the fluid tank 517. In this manner, a length of one of the landing gear skirts 554L, 554R may be different than the other of the landing gear skirts 554L, 554R.

The forward wall panel 584F includes a top edge 587F, a bottom edge 589F, a forward edge 591F, and a rear edge 593F, as shown in FIG. 17. Illustratively, the top edge 587F has a first length and the bottom edge 589F has a shorter second length so that the forward edge 591F is non-perpendicular to the floor 516, and the rear edge 593F is generally perpendicular to the floor 516, as shown in FIG. 17. The rear wall panel 584R includes a top edge 587R, a bottom edge 589R, a forward edge 591R, and a rear edge 593R. Illustratively, the top edge 587 has a first length and the bottom edge 589 has a shorter second length so that the rear edge 593R is non-perpendicular to the floor 516 and the forward edge 591F is generally perpendicular to the floor 516, as shown in FIG. 17.

The side skirt 556 can be non-parallel with the either the right side 540 or the left side 538 of floor 516 of the trailer 412, as shown in FIG. 18. Illustratively, the left side skirt 556L has a front edge 595L facing the front side 536 of the floor 516 and a rear edge 597L facing the back side 542 of the floor 516. The left side skirt 556L is angled relative to the floor so that front edge 595 of the left side skirt 556L is closer to the right side 540 of the floor 516 than the rear edge 597L of the left side skirt 556L. The right side skirt 556R is oriented in an equivalent manner. Illustratively, the front edge 595L of the left side skirt 556L is located between the back edge 580 of the landing gear skirt 554 and the rear wheel assembly 518 and is angled to be nearer the left side 538 of the floor 516 than the landing gear skirt 554, as shown in FIGS. 16 and 18.

As best seen in FIGS. 15 and 18, the landing gear 20 and/or landing gear support leg 48 in any of the embodiments disclosed herein may be located within a footprint of the left landing gear skirt 454L, 554L and/or the right landing gear skirt 454R, 554R when the trailer is viewed from the left or right side, respectively, of the trailer. More particularly, in any of the embodiments herein, the landing gear 20 and/or landing gear support leg 48 may be obstructed from view from one or both of the left side or the right side by the landing gear skirts 454L, 554L or 454R, 554R, respectively. In some embodiments, a longitudinal extent (i.e., along a length of the trailer) of the landing gear skirts 454L, 554L and/or 454R, 554R is equal to or greater than a longitudinal extent of the landing gear 20 and/or landing gear support leg 48. In illustrative embodiments, one or both longitudinal ends of one or both of the landing gear skirts 454L, 554L and/or 454R, 554R may have a longitudinal extent that is the same as or greater than a longitudinal extent of the landing gear 20 and/or landing gear support leg 48. In illustrative embodiments, the landing gear skirts 454L, 554L and/or 454R, 554R extend beyond the landing gear 20 and/or landing gear support leg 48 in at least one of a forward direction (toward the front side of the floor 536) or in a rearward direction (toward the back side 542 of the floor). In other illustrative embodiments, the landing gear skirts 454L, 554L and/or 454R, 554R extend beyond the landing gear 20 and/or landing gear support leg 48 in both the forward direction (toward the front side of the floor 536) and in the rearward direction (toward the back side 542 of the floor). The landing gear skirts discloses herein provide a smooth air flow around the landing gear 20 and/or landing gear support leg 48 to reduce drag that may be caused by the existence and positioning of the landing gear.

In other illustrative embodiments, the landing gear 20 and/or landing gear support leg 48 may be outside of the footprint of one or both of the landing gear skirts. Still alternatively, the landing gear 20 and/or landing gear support leg 48 may be partially or fully within a footprint of both the landing gear skirt and/or other skirt sections, such that the landing gear skirts and/or other skirt sections block the landing gear 20 and/or landing gear support leg 48 when viewing the trailer from the side. In still other embodiments, the landing gear 20 and/or landing gear support leg 48 may be within a footprint of the overall skirt, regardless of how many skirt sections or panels are utilized.

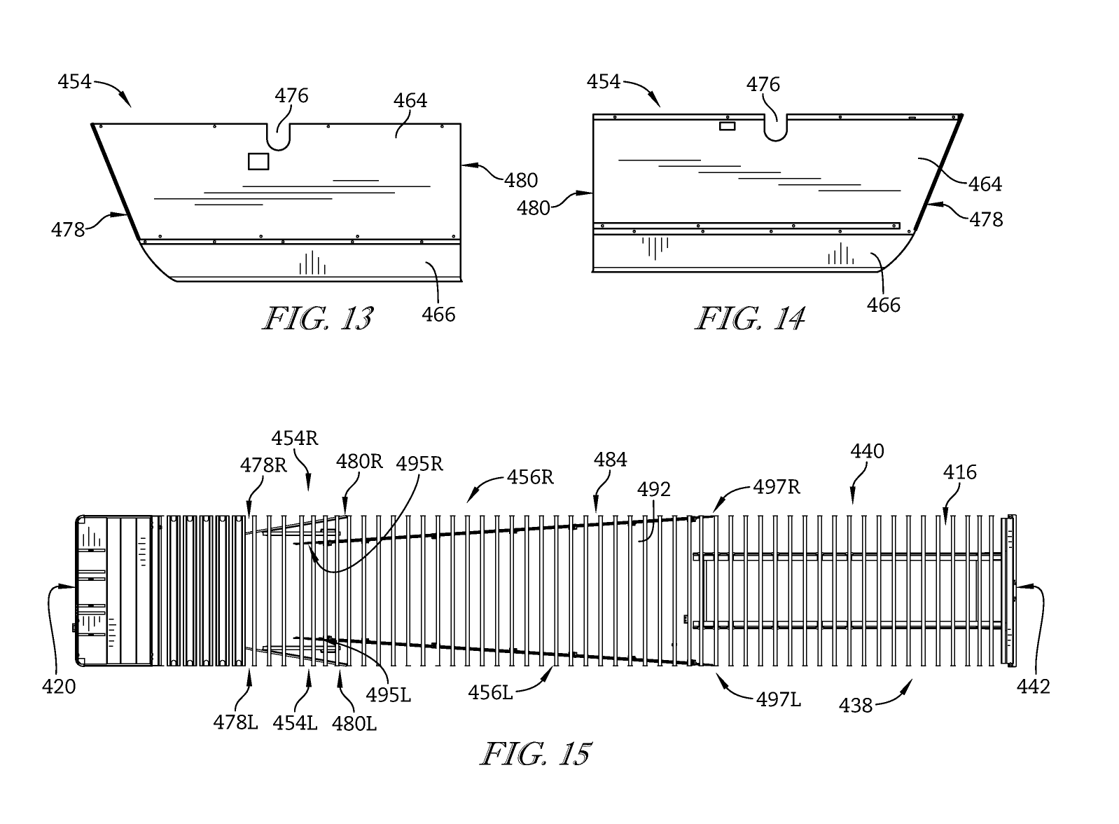

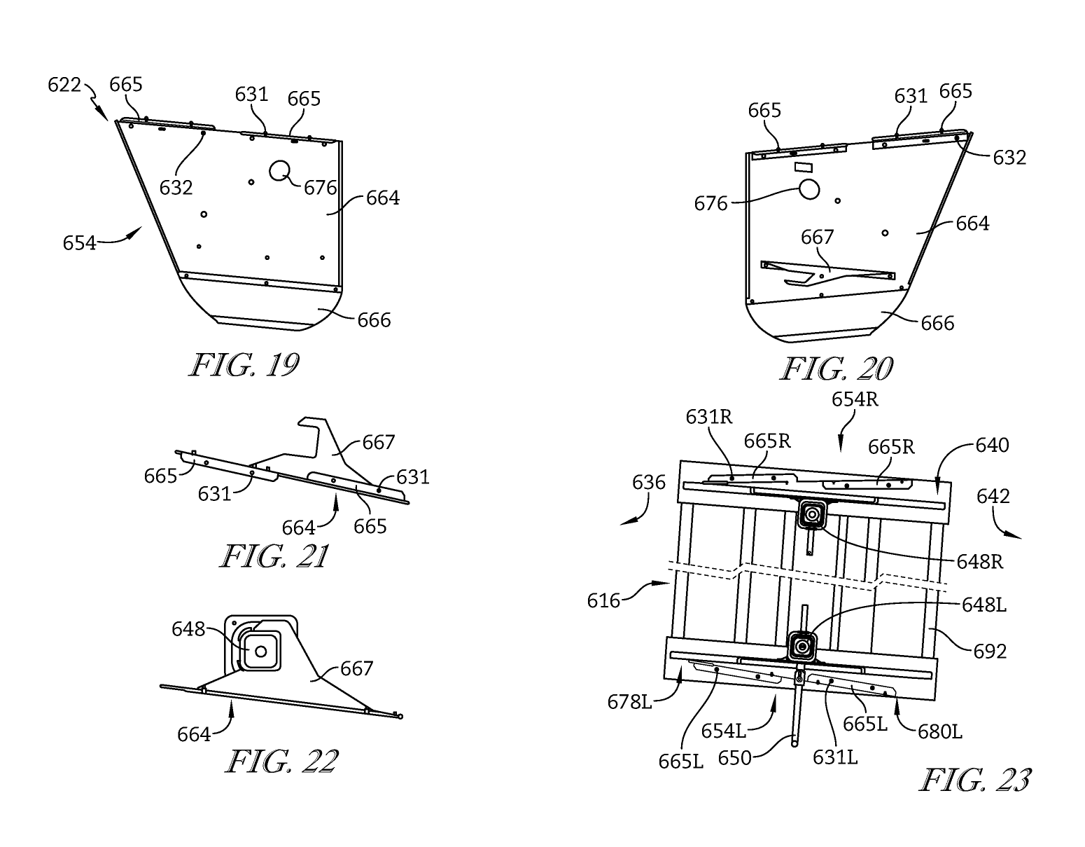

In another embodiment, a skirt system 622 includes a landing gear skirt 654, and a side skirt 656 to improve the airflow around the trailer 512, as seen in FIGS. 19-13. Illustratively, the side skirt 656 can be similar to any of the side skirts 56, 256, 356, 456 or 556.

The landing gear skirt 654 includes a wall panel 664, flanges 665, a landing gear mount bracket 667, and a flexible bottom flap 666, as shown in FIG. 19. The landing skirt 654 can be rigidly coupled to a floor 616 of a trailer 612 using the flanges 665, and can be coupled to the landing gear support leg 648 with the landing gear mount bracket 667. The flanges 665 include apertures 631, 632 and are configured for rigidly coupling the landing gear skirt wall panel 664 to the floor 616 of the trailer 612, as shown in FIGS. 19-23. The landing gear mount bracket 667 is configured to couple to the wall panel 664 and to the landing gear support leg 648, as shown in FIGS. 21 and 22. Illustratively, the landing gear skirt wall panel 664 includes an aperture 676 sized for crank handle 650 to pass therethrough, as shown in FIGS. 19 and 23.

Illustratively, the left landing gear skirt 654L has a front edge 678L facing the front side 636 of the floor 616 and a back edge 680L facing the back side 642 of the floor 616 as seen in FIG. 23. The left landing gear skirt 664L is angled relative to the floor so that front edge 678L of the left landing gear skirt 654L is closer to the right side 640 of the floor 616 than the back edge 680 of the left landing gear skirt 654L. Orienting the landing gear skirt 654 in such a manner may lead to improved uptake of the air flow from underneath the trailer 612. Illustratively the right landing gear skirt 654R is oriented in an equivalent manner.

The landing gear skirts disclosed herein mount to the floor 16, which may be called the underside, of the trailer 12 between the side gear and the side face of the trailer. The landing gear skirt can be a flat panel that may be mounted rigidly at a slight angle.

The landing gear skirts disclosed herein may improve fuel economy by deflecting air away from the front side 36, sometimes called the front underside, of the trailer 12 and allowing the flow to attach to the side skirt 56, which may be called the main skirt panels, quicker. Additionally, there may be a gap between the landing gear skirt and the side skirt, which may be called the main skirt panel, that allows trapped air from underneath to pass through as well. Another added benefit can be visual inspection of the fifth wheel.

The landing gear skirts disclosed herein may offer significant improvement in fuel economy for a small amount of material. The landing gear skirt may be used for pup trailers but could also be used on refrigerated or dry van trailers.

The landing gear skirts disclosed herein may reduce drag by deflecting or redirecting air flow that would otherwise hit portions of the landing gear 20, for example, landing gear braces, cross braces, legs, etc., away from these components. The drag that would have been caused by air flow hitting these components is reduced, thereby increasing aerodynamic efficiency of trailer 12.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

The following paragraphs include embodiments that are contemplated and non-limiting:

In an illustrative embodiment, a skirt system for a trailer comprises a left landing gear skirt configured to be attached to a left side of a floor of a trailer, a right landing gear skirt configured to be attached to a right side of the floor of a trailer, and an aperture formed within one of the left and right landing gear skirts, the aperture configured for insertion of a landing gear crank handle.

In some embodiments, the skirt system includes a left side skirt and a right side skirt, the left side skirt configured to be attached to the left side of the floor between the left landing gear skirt and a rear wheel assembly, and the right side skirt configured to be attached to the right side of the floor between the right landing gear skirt and the rear wheel assembly.

In some embodiments, the aperture is formed in the left landing gear skirt and a second aperture is formed within the right landing gear skirt and is configured for insertion of the landing gear crank handle.

In some embodiments, the aperture is disposed adjacent a top edge of the one of the left and right landing gear skirts.

In some embodiments, each of the left and right landing gear skirts comprises a wall panel having a first stiffness, the wall panel configured for attachment to the floor and a flexible bottom flap that extends downwardly from the wall panel and has a second stiffness less than the first stiffness.

In some embodiments, each wall panel includes a bottom edge, a top edge, a forward edge and a rear edge, the rear edge extends generally perpendicular to the top edge, and the forward edge extends generally non-perpendicular to the top edge.

In some embodiments, each top edge of the wall panel has a first length and the bottom edge has a generally shorter second length.

In some embodiments, front edges of the left landing gear skirt and the right landing gear skirt have a generally triangular shape with an apex arranged to form a forward-most point of the front edge, the apex of the front edge is located about midway between a top edge and a bottom edge of the landing gear skirt, and a rear edge of each of the left landing gear skirt and the right landing gear skirt has a generally triangular shape cutout and an apex arranged to form the forward-most point of the rear edge, the apex of the rear edge is located about midway between the top edge and the bottom edge of the landing gear skirt.

In some embodiments, the skirt system includes a left wheel assembly skirt and a right wheel assembly skirt, the left wheel assembly skirt being configured to be attached to the floor between the left side skirt and a rear of the trailer, and the right wheel assembly skirt being configured to be attached to the floor between the right side skirt and the rear of the trailer.

In some embodiments, the skirt system includes a left rear skirt configured to be positioned between the left wheel assembly skirt and the rear of the trailer and a right rear skirt configured to be positioned between the right wheel assembly skirt and the rear of the trailer.

In some embodiments, each of the left and right side skirts includes a plurality of side skirt panels.

In some embodiments, each of the left and right landing gear skirts is made of a composite material.

In an illustrative embodiment, a trailer may comprise a floor having a front side, a back side, a left side and a right side; a rear wheel assembly coupled to the floor; a landing gear coupled to the floor between the rear wheel assembly and the front side of the floor, the landing gear including at least one support leg moveable from a stowed position to a use position; and a skirt system including a left landing gear skirt that extends downwardly from and along the left side of the floor, and a right landing gear skirt that extends downwardly from and along the right side of the floor, wherein the landing gear is located entirely within a footprint of the left landing gear skirt and the right landing gear skirt when the trailer is viewed from the left side or the right side of the trailer.

In some embodiments, the skirt system may include a left side skirt and a right side skirt, the left side skirt extends downwardly from and is located along the left side of the floor between the left landing gear skirt and the rear wheel assembly, and the right side skirt extends downwardly from and is located along the right side of the floor between the right landing gear skirt and the rear wheel assembly.

In some embodiments, each of the left landing gear skirt and the right landing gear skirt may include a mount bracket assembly coupled to the floor, a wall panel that has extends downwardly from the mount bracket assembly and has a first stiffness, and a flexible bottom flap that extends downwardly from the wall panel and has a second stiffness less than the first stiffness.

In some embodiments, the wall panel may be formed to include an aperture sized to allow passage of a landing gear crank handle therethrough and an aperture is arranged along a top side of the wall panel adjacent to the floor of the trailer.

In some embodiments, each wall panel may include a bottom edge, a top edge, a forward edge and a rear edge, the rear edge extends generally perpendicular to the floor of the trailer, and the forward edge extends generally non-perpendicular to the floor of the trailer.

In some embodiments, each top edge of the wall panel may have a first length and the bottom edge has a generally shorter second length.

In some embodiments, each mount bracket assembly may include a mount plate coupled to the floor, a channel mount configured to be coupled to the wall panel of one of the left landing gear skirt or the right landing gear skirt and movable relative to the mount plate, and a spring coupled to the mount plate and to the channel mount to bias the channel mount toward a position in which the wall panel of one of the left landing gear skirt or the right landing gear skirt extends downwardly from the floor to form a right angle with the floor.

In some embodiments, the spring may be arranged at least in part within a downwardly-opening channel defined by the plate and the mount.

In some embodiments, the left landing gear skirt may have a front edge facing the front side of the floor and a back edge facing the back side of the floor, the right landing gear skirt may have a front edge facing the front side of the floor and a back edge facing the back side of the floor, the left landing gear skirt angled relative to the floor so that the front edge of the left landing gear skirt is closer to the right side of the floor than the back edge of the left landing gear skirt, and the right landing gear skirt angled relative to the floor so that the front edge of the right landing gear skirt is closer to the left side of the floor than the back edge of the right landing gear skirt.

In some embodiments, the front edge of each of the left landing gear skirt and the right landing gear skirt may have a generally triangular shape with an apex arranged to form a forward-most point of the front edge, the apex of the front edge is located about midway between a top edge and a bottom edge of the landing gear skirt, and the rear edge of each of the left landing gear skirt and the right landing gear skirt may have a generally triangular shape cutout and an apex arranged to form the forward-most point of the rear edge, the apex of the rear edge is located about midway between the top edge and the bottom edge of the landing gear skirt.

In some embodiments, the left landing gear skirt may be spaced apart from the left side skirt along the left side of the floor, and the right landing gear skirt may be spaced apart from the right side skirt along the right side of the floor.

In some embodiments, the skirt system may include a left rear skirt and a right rear skirt, the left rear skirt may extend downwardly from and is located along the left side of the floor between the rear wheel assembly and the back side of the floor, and the right rear skirt may extend downwardly from and is located along the right side of the floor between the rear wheel assembly and the back side of the floor.

In some embodiments, the skirt system may include a left wheel assembly skirt and a right wheel assembly skirt, the left wheel assembly skirt may extend downwardly from the floor and along the left side of the floor, and the right wheel assembly skirt may extend downwardly from the floor and along the right side of the floor, and wherein the rear wheel assembly may be located within a footprint of the left wheel assembly skirt and the right wheel assembly skirt when the trailer is viewed from the left side or the right side of the trailer.

In some embodiments, the left landing gear skirt, the left side skirt, the left wheel assembly skirt and the left rear skirt may be connected to one another without spaces therebetween along the left side of the floor to form a continuous left skirt surface.

In some embodiments, each of the left side skirt and the right side skirt may include a plurality of side skirt panels, the plurality of side skirt panels of the left side skirt may extend downwardly from and are spaced apart from one another along the left side of the floor between the left landing gear skirt and the rear wheel assembly, and the plurality of side skirt panels of the right side skirt may extend downwardly from and are spaced apart from one another along the right side of the floor between the right landing gear skirt and the rear wheel assembly.

In some embodiments, the skirt system may include a left rear skirt and a right rear skirt, the left rear skirt may extend downwardly from the floor and is located along the left side of the floor between the rear wheel assembly and the back side of the floor, and the right rear skirt may extend downwardly from the floor and is located along the right side of the floor between the rear wheel assembly and the back side of the floor.

In some embodiments, the left side skirt may have a front edge facing the front side of the floor and a back edge facing the back side of the floor, the right side skirt may have a front edge facing the front side of the floor and a back edge facing the back side of the floor, the left side skirt may be angled relative to the floor so that the front edge of the left side skirt is closer to the right side of the floor than the back edge of the left side skirt, and the right side skirt may be angled relative to the floor so that the front edge of the right side skirt is closer to the left side of the floor than the back edge of the right side skirt.

In some embodiments, each of the left side skirt and the right side skirt may include a plurality of side skirt panels, the plurality of side skirt panels of the left side skirt may extend downwardly from and are spaced apart from one another along the left side of the floor between the left landing gear skirt and the rear wheel assembly, and the plurality of side skirt panels of the right side skirt may extend downwardly from and are spaced apart from one another along the right side of the floor between the right landing gear skirt and the rear wheel assembly.

In some embodiments, the front edge of the left side skirt may be located between the front side of the floor and a back edge of the left landing gear skirt and the front edge of the right side skirt may be located between the front side of the floor and the back edge of the right landing gear skirt.

In another illustrative embodiment, a method of installing a skirt system to a trailer comprises the steps of coupling a skirt system to a floor of a trailer, the skirt system including a left landing gear skirt that extends downwardly from and along a left side of the floor, and a right landing gear skirt that extends downwardly from and along a right side of the floor and positioning a crank handle extending from landing gear attached to a bottom of the trailer within an aperture formed within one of the left and right landing gear skirts.

In some embodiments, the skirt system is coupled to the floor of the trailer such that the landing gear support leg is located entirely within a footprint of the left landing gear skirt and the right landing gear skirt when the trailer is viewed from the left side or the right side of the trailer.

In some embodiments, the coupling step includes the step of coupling the left and right landing gear skirts to the floor such a distance between a front edge of the left landing gear skirt and a front edge of the right landing gear skirt is less than a distance between a rear edge of the left landing gear skirt and a rear edge of the right landing gear skirt.

We claim:

1. A skirt system for a trailer, the skirt system comprising:
a left landing gear skirt configured to be attached to a left side of a floor of a trailer;
a right landing gear skirt configured to be attached to a right side of the floor of a trailer;
an aperture formed within one of the left and right landing gear skirts, the aperture configured for insertion of a landing gear crank handle.

2. The skirt system of claim 1, further including a left side skirt and a right side skirt, the left side skirt configured to be attached to the left side of the floor between the left landing gear skirt and a rear wheel assembly, and the right side skirt configured to be attached to the right side of the floor between the right landing gear skirt and the rear wheel assembly.

3. The skirt system of claim 1, wherein the aperture is formed in the left landing gear skirt and a second aperture is formed within the right landing gear skirt and is configured for insertion of the landing gear crank handle.

4. The skirt system of claim 1, wherein the aperture is disposed adjacent a top edge of the one of the left and right landing gear skirts.

5. The skirt system of claim 1, wherein each of the left and right landing gear skirts comprises:
a wall panel having a first stiffness, the wall panel configured for attachment to the floor; and
a flexible bottom flap that extends downwardly from the wall panel and has a second stiffness less than the first stiffness.

6. The skirt system of claim 5, wherein each wall panel includes a bottom edge, a top edge, a forward edge and a rear edge, the rear edge extends generally perpendicular to the top edge, and the forward edge extends generally non-perpendicular to the top edge.

7. The skirt system of claim 6, wherein each top edge of the wall panel has a first length and each bottom edge has a generally shorter second length.

8. The skirt system of 1, wherein front edges of the left landing gear skirt and the right landing gear skirt have a generally triangular shape with an apex arranged to form a forward-most point of the front edge, the apex of the front edge is located about midway between a top edge and a bottom edge of the landing gear skirt, and a rear edge of each of the left landing gear skirt and the right landing gear skirt has a generally triangular shape cutout and an apex arranged to form the forward-most point of the rear edge, the apex of the rear edge is located about midway between the top edge and the bottom edge of the landing gear skirt.

9. The skirt system of claim 2, further including a left wheel assembly skirt and a right wheel assembly skirt, the left wheel assembly skirt being configured to be attached to the floor between the left side skirt and a rear of the trailer, and the right wheel assembly skirt being configured to be attached to the floor between the right side skirt and the rear of the trailer.

10. The skirt system of claim 9, further including a left rear skirt configured to be positioned between the left wheel assembly skirt and the rear of the trailer and a right rear skirt configured to be positioned between the right wheel assembly skirt and the rear of the trailer.

11. The skirt system of claim 2, wherein each of the left and right side skirts includes a plurality of side skirt panels.

12. The skirt system of claim 1, wherein each of the left and right landing gear skirts is made of a composite material.

13. A trailer, comprising:
a floor having a front side, a back side, a left side and a right side;
a rear wheel assembly coupled to the floor;
a landing gear coupled to the floor between the rear wheel assembly and the front side of the floor, the landing gear including at least one support leg moveable from a stowed position to a use position; and
a skirt system including a left landing gear skirt that extends downwardly from and along the left side of the floor, and a right landing gear skirt that extends downwardly from and along the right side of the floor,
wherein the landing gear support leg is located entirely within a footprint of the left landing gear skirt and the right landing gear skirt when the trailer is viewed from the left side or the right side of the trailer.

14. The trailer of claim 13, wherein each of the left landing gear skirt and the right landing gear skirt includes a mount bracket assembly coupled to the floor, a wall panel that extends downwardly from the mount bracket assembly and has a first stiffness, and a flexible bottom flap that extends downwardly from the wall panel and has a second stiffness less than the first stiffness.

15. The trailer of claim 13, wherein one of the left and right landing gear skirts is formed to include an aperture sized to allow passage of a landing gear crank handle therethrough and the aperture is arranged along a top side of the one of the left and right landing gear skirts adjacent to the floor of the trailer.

16. The trailer of claim 15, wherein the aperture is disposed adjacent a top edge of the one of the left and right landing gear skirts.

17. The trailer of claim 3, wherein the skirt system further includes:
a left side skirt that extends downwardly from and is located along the left side of the floor between the left landing gear skirt and the rear wheel assembly;
a right side skirt that extends downwardly from and is located along the right side of the floor between the right landing gear skirt and the rear wheel assembly.
a left wheel assembly skirt that extends downwardly from the floor and along the left side of the floor; and
a right wheel assembly skirt that extends downwardly from the floor and along the right side of the floor;
wherein the left landing gear skirt, the left side skirt, and the left wheel assembly skirt are connected to one another without spaces therebetween along the left side of the floor to form a continuous left skirt surface and the right landing gear skirt, the right side skirt, and the right wheel assembly skirt are all connected to one another without spaces therebetween along the right side of the floor to form a continuous right skirt surface.

18. A method of installing a skirt system to a trailer, the method comprising the steps of:
coupling the skirt system to a floor of a trailer, the skirt system including a left landing gear skirt that extends downwardly from and along a left side of the floor, and a right landing gear skirt that extends downwardly from and along a right side of the floor; and
positioning a crank handle extending from landing gear attached to a bottom of the trailer within an aperture formed within one of the left and right landing gear skirts.

19. The method of claim 18, wherein the skirt system is coupled to the floor of the trailer such that a landing gear support leg is located entirely within a footprint of the left landing gear skirt and the right landing gear skirt when the trailer is viewed from the left side or the right side of the trailer.

20. The method of claim 18, wherein the coupling step includes the step of coupling the left and right landing gear skirts to the floor such a distance between a front edge of the left landing gear skirt and a front edge of the right landing gear skirt is less than a distance between a rear edge of the left landing gear skirt and a rear edge of the right landing gear skirt.
